(19) United States
(12) Patent Application Publication
(10) Pub. No.: US 2016/0123235 A1
(43) Pub. Date: May 5, 2016

(54) ARRANGEMENT AND METHOD FOR BLOWING-OFF COMPRESSOR AIR IN A JET ENGINE

(71) Applicant: Rolls-Royce Deutschland Ltd & Co KG, Blankenfelde-Mahlow (DE)

(72) Inventors: Jean-Marc SIERING, Berlin (DE); Klaus HELMING, Zossen (DE)

(21) Appl. No.: 14/882,917

(22) Filed: Oct. 14, 2015

(30) Foreign Application Priority Data
Oct. 16, 2014 (DE) 10 2014 221 049.6

(51) Int. Cl. F02C 9/18

(52) U.S. Cl. CPC F02C 9/18

(57) ABSTRACT

An assembly and a method for bleeding of compressor air in an engine is provided. The assembly includes a bleed channel for bleeding compressor air. It is provided that the channel geometry of the bleed channel is adjustable.

### REFERENCE TO RELATED APPLICATION

This application claims priority to German Patent Application No. 10 2014 221 049.6 filed on Oct. 16, 2014, the entirety of which is incorporated by reference herein.

### BACKGROUND

The invention relates to an assembly and a method for bleeding compressor air in an engine.

In compressors of an engine, it is known to vary the mass flow through the compressor by abstracting compressor air in order to optimize its aerodynamic stability. In addition, bleeding of compressor air serves the purpose of preventing unstable operating statuses in a low-pressure compressor.

For controlling bleeding of compressor air, it is known in the state of the art to provide flap systems or discs by means of which the bleed channel through which the compressor air is bled can be either opened or closed. For example, an assembly for abstraction of compressor air from a low-pressure compressor is known from the printed publication U.S. Pat. No. 5,044,153 A, where pivotable valve flaps for closing or opening a bleed channel are provided in the wall of the low-pressure compressor. Such an assembly for variable bleeding of compressor air of a low-pressure compressor is also referred to as a BBV system (BBV=“booster bleed valve”).

In BBV systems of the state of the art, it is possible to adjust simple valve flaps or other sealing means of a bleed channel. This is accompanied by strong air turbulences. As a result of such turbulences, high pressure losses occur which may in turn result in such a low pressure ratio to the bypass duct occurring in part-load areas of the low-pressure compressor that bleeding of the necessary mass flow is no longer possible. Moreover, such turbulences lead to an undesired increase of noise as well as to loss of efficiency.

There is a need to provide assemblies in which it is possible to adjust the mass flow that is guided through a bleed channel in a defined manner, and in which such an adjustment of the mass flow is not accompanied by the described disadvantages.

### SUMMARY

Accordingly, the present invention is based on the objective to provide an assembly and a method for bleeding compressor air in an engine, in which a defined and low-loss adjustment of the mass flow guided through the bleed channel is facilitated.

According to the invention, the objective is solved by an assembly with the features as described herein and a method with the features as described herein.

According to these, the solution according to the invention is characterized by the fact that the channel geometry of the bleed channel is adjustable. The invention is thus based on the idea to seal or partially seal a bleed channel, and namely not by means of a sealing element, but by embodying the channel geometry of the bleed channel itself in a variable manner, so that at least one local modification in the geometry of the bleed channel can be provided. Here, the altered channel geometry corresponds to a modification of the cross-sectional surface of the bleed channel at least in a partial area and thus facilitates a defined adjustment of the air flow in the bleed channel.

The cross-sectional surface, the modification of which is accompanied by a modification of the channel geometry, is formed here by the exterior boundary surfaces of the bleed channel, i.e. by those structures that externally confine the gas flow as they form the bleed channel. Thus, the solution according to the invention does not focus on assemblies in which an additional object is inserted into the bleed channel and in which a reduced cross-sectional surface may become available for the gas flow due to such an object. Rather, the invention focuses on a modification of the channel geometry itself, that is, what takes place is a modification of the geometry with regard to the exterior boundary surfaces of the bleed channel and, in the case of an adjustment, an at least local modification of the cross-sectional surface.

Thus, the channel geometry and the cross-sectional surface of the bleed channel through which the flow passes can preferably be adjusted downstream of an opening through which the compressor air to be bled reaches the bleed channel. Accordingly, an exterior boundary surface of the bleed channel (provided downstream of the opening) is adjustable obliquely to the flow direction of the compressor air in at least one partial area in order to at least locally modify the bleed channel's channel geometry inside of the bleed channel and to adjust it in a variable manner.

According to one embodiment of the invention, it is provided that the assembly comprises means by which the cross-sectional surface of the bleed channel can be modified at least in a partial area of the bleed channel. Preferably, such means are designed in such a manner that the cross-section of the bleed channel can be modified continuously. In this way it becomes possible to continuously adjust the mass flow through the bleed channel.

In one embodiment of the invention, it is provided that the bleed channel comprises a displaceable element which, in a partial area of the bleed channel, forms its limitation with respect to the fluid that is flowing within the bleed channel. The channel geometry is changed as the displaceable element is displaced in flow direction of the bleed channel. The channel geometry may for example be changed in such a manner that the minimal cross-sectional surface of the bleed channel is modified.

The displaceable element can be embodied as a displaceable throttle and comprise an element that is embodied in a disc-shaped or ring-shaped manner, for example. Preferably it is provided that the displaceable element is shaped in a convex manner towards the interior of the bleed channel, forming a continuous transition to the adjacent boundary surfaces without any points of discontinuity, so that it is passed by the flow with flow losses that are as small as possible.

Further, it can be provided that the displaceable element is arranged in a section of the bleed channel that extends substantially in parallel to a bypass duct into which the compressor air is bled. Such a section of the bleed channel that is extending in parallel to the bypass duct result in a parallel guiding of the air flow within the bleed channel and the bypass duct, so that it is advantageously facilitated that the air flows are merged with only a low degree of turbulence and consequently with high efficiency.

In another embodiment it is provided that the displaceable element is arranged in a section of the bleed channel that tapers off and/or that is embodied in a curved manner. Displacement of the displaceable element in such a section either in or against the flow direction automatically leads to the realization of a different minimal cross-sectional surface of the bleed channel that depends on the position of the displaceable element.

It is provided in another embodiment of the invention that at least one channel segment that confines the bleed channel is embodied in an adjustable manner. According to this embodiment, a boundary surface of the bleed channel is adjusted as a whole in its position at least in a partial area, thus changing the channel geometry. For this purpose, it can for example be provided that a channel segment is displaceable inside the bleed channel substantially obliquely with respect to the the flow direction. According to an embodiment variant, it is provided that a channel segment is displaceable in the axial direction, wherein the axial direction refers to the longitudinal extension direction of an engine inside of which the assembly according to the invention is arranged.

In another embodiment of the invention it is provided that the bleed channel is confined by a plurality of channel segments and that at least some of the channel segments are embodied in an adjustable manner, namely in such a way that the distance of the channel segments to each other can be modified.

In one embodiment of the invention, the at least one displaceable channel segment forms a front or a rear axial limitation of the bleed channel in one area of the bleed channel in which it extends in a direction that comprises a radial component. For example, the displaceable channel segment can be embodied at the rear section of a splitter, as seen in flow direction, with the splitter separating the primary flow channel from the bypass duct of the engine. According to another embodiment, the displaceable channel segment is formed by a front section of a housing area, as seen in the flow direction, with the housing connecting to such a splitter in the axial direction.

The displaceable channel segment necessarily forms a transition area to the stationary housing segments that are not adjustable. According to one embodiment of the invention, such a transition area is provided through a parallel guide by means of overlapping housing parts, for one thing of the displaceable channel segment and for another thing of a stationary housing segment. Alternatively, such a transition area can be realized by way of a telescopic slide of the displaceable channel segment at the stationary housing segment, for example.

The provided means for adjusting the channel geometry may for example be provided through an actuator that is arranged at the housing side in a stationary manner and that is connected to the means for adjusting the channel geometry via mechanical coupling elements, such as e.g. connecting rods.

Even as the geometry of a bleed channel can be changed as a whole through the assembly according to the invention, a sealing element for the complete sealing of the bleed channel can additionally be provided according to one embodiment variant of the present invention. For example, such a sealing element makes it possible to completely seal a bleed channel, while the adjustability of the channel geometry according to the invention is used for adjusting the mass flow of the air which is guided through the bleed channel in the open state of the sealing element.

According to an exemplary embodiment, the assembly according to the invention is embodied for the purpose of introducing compressor air from the primary flow channel of a turbofan engine into a bypass duct of the turbofan engine via the bleed channel.

The invention also relates to a method for bleeding compressor air in an engine in which the compressor air to be bled from a compressor of the engine is guided into a bleed channel. It is provided in the method that the channel geometry of the bleed channel is modified for the purpose of adjusting the mass flow of the compressor air to be bled.

### BRIEF DESCRIPTION OF THE DRAWINGS

In the following, the invention is described in more detail by referring to the figures of the drawing based on several exemplary embodiments.

FIG. 1 shows a longitudinal section through a first exemplary embodiment of an assembly for bleeding compressor air in an engine, comprising a bleed channel which is adjustable in its channel geometry.

FIG. 2A shows a view of the partial area X of FIG. 1 in a first state.

FIG. 2B shows a view of the partial area X of FIG. 1 in a second state.

FIG. 3 shows a longitudinal section through a second exemplary embodiment of an assembly for bleeding compressor air in an engine, comprising a bleed channel that is adjustable in its channel geometry.

FIG. 4A shows a view of the partial area X of FIG. 3 in a first state.

FIG. 4B shows a view of the partial area X of FIG. 3 in a second state.

FIG. 5 shows a longitudinal section through a third exemplary embodiment of an assembly for bleeding compressor air in an engine, comprising a bleed channel that is adjustable in its channel geometry.

FIG. 6A shows a view of the partial area X of FIG. 5 in a first state.

FIG. 6B shows a view of the partial area X of FIG. 5 in a second state.

FIG. 7 shows a longitudinal section through a fourth exemplary embodiment of an assembly for bleeding compressor air in an engine, comprising a bleed channel that is adjustable in its channel geometry.

### DETAILED DESCRIPTION

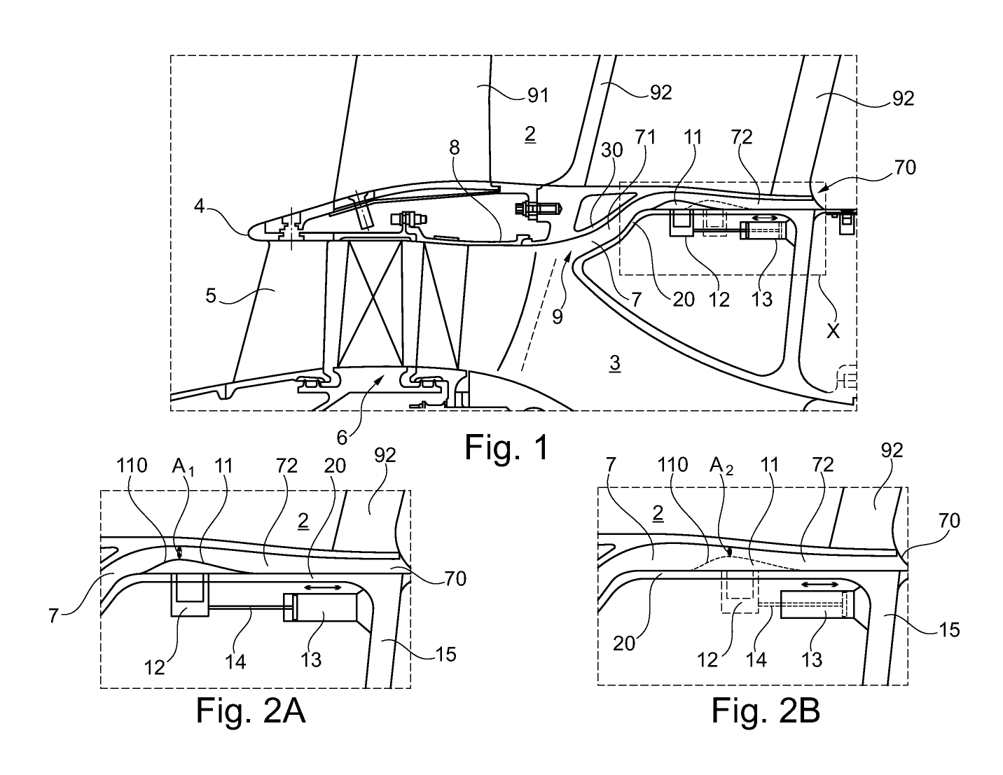

FIG. 1 shows components of a turbofan engine. The shown section of a turbofan engine comprises a bypass duct 2 and a primary flow channel 3 into which an air mass that is sucked in by a fan (not shown) is guided. Here, the bypass duct 2 and the primary flow channel 3 are separated from each other behind the fan by a splitter 4. The primary flow channel 3 leads through the core engine. In the case of a two-shaft engine, the core engine comprises a low-pressure compressor 6, a high-pressure compressor, a combustion chamber, a high-pressure turbine and a low-pressure turbine.

In the context of the present invention, what is relevant is the bleeding of compressor air from the low-pressure compressor 6. However, it is to be understood that the principles of the invention, which will be explained in the following by referring to bleeding the compressor air of a low-pressure compressor, can also be used in the same way for bleeding compressor air of a high-pressure compressor or a medium-pressure compressor (in a three-shaft engine), for example.

The low-pressure compressor 6 comprises a compressor stage that is also referred to as a booster stage. It is also possible to provide multiple compressor stages instead of one compressor stage. A guide wheel 5 is arranged in front of the low-pressure compressor 6 in the beginning of the primary flow channel 3, serving the purpose of taking out from the air flow the momentum that it has gained in that area of the fan that is located in the vicinity of the hub.

A guide wheel 91 as well as support struts 92 are arranged in the bypass duct 2.

The low-pressure compressor 6 is surrounded by a circumferential housing 8 that confines the primary flow channel 3 radially externally. Radially internally, the primary flow channel 3 is formed by corresponding rim surfaces of the rotors and stators, or by the hub or the elements of the corresponding drive shaft connected to the hub.

Behind the low-pressure compressor 6, as viewed in the flow direction, the circumferential housing 8 comprises an opening 9 that opens towards a bleed channel 7. The bleed channel 7 serves for bleeding the compressor air of the low-pressure compressor 6. The bleed channel 7 blows the compressor air into the bypass duct 2 and accordingly, at its rear end 70, has an opening into the bypass duct 2 or alternatively into structures that are in turn connected to the bypass duct 2. The arrangement of the bleed channel 7 is shown only by way of example here in FIG. 1.

The opening 9 in the primary flow channel 3 into the bleed channel 7 can be embodied in a circumferential manner or be comprised of a plurality of openings that are evenly distributed around the circumference. The bleed channel 7 can be embodied in a rotationally symmetric manner. However, it can be interrupted by structural elements, for example of an intermediate housing (IMC) that receives structural loads.

The bleed channel 7 has a channel geometry which can be adjusted in such a way that the mass flow of the compressor air which is bled through the bleed channel 7 can be adjusted in a defined manner. This will be described in the following based on several embodiment variants.

The bleed channel 7 is confined by walls that can be embodied in multiple parts. The walls comprise an axially frontal wall 30 and an axially rear wall 20.

As can in particular be seen in the partial views of FIGS. 2A, 2B, a displaceable element 11 is located inside the bleed channel 7, representing the exterior boundary surfaces 110 in the bleed channel 7 for the fluid flowing inside the bleed channel 7. Here, the boundary surfaces 110 are embodied in a convex manner so that the flow passes by the displaceable element 11 in a substantially laminar manner and without turbulences.

Although this is not obligatory, in the shown exemplary embodiment the displaceable element 11 is located in a section 72 of the bleed channel 7 that extends substantially in the axial direction and accordingly substantially in parallel to the bypass duct 2. In addition, adjacent to the opening 9, the bleed channel 7 comprises a section 71 that has a radial component with respect to its extension direction.

Through the displacement of the displaceable element 11, the cross-sectional surface in section 72 of the bleed channel 7, i.e. that surface in the cross-sectional view through which the air to be bled can be transported, may be modified.

The displaceable element 11 is displaceable within the section 72 in the flow direction of the bleed channel 7, which in the regarded exemplary embodiment is in the axial direction. The axial displaceability is provided by an actuator 13 that is arranged in a stationary manner and is connected to a stationary strut 15 or another stationary housing structure. The actuator 13 is connected via a coupling rod 14 or another coupling means to a connection part 12 that protrudes through a recess, for example a slit (not separately shown), present in the one wall 20 and is fixedly connected to the displaceable element 11. Adjacent to the displaceable element 11, the wall 20 represents the exterior boundary surface of the one side of the bleed channel 7. But in the area of the displaceable element 11 and on that one of its sides that is facing towards the bleed channel 7, the wall 20 is covered by the displaceable element 11, with the latter's surface 110 representing the exterior boundary surface of the one side of the bleed channel 7.

The displaceable element 11 can be axially displaced in section 72 of the bleed channel 7 by means of the actuator 13, the coupling rod 14 and the connection part 12. FIGS. 2A, 2B show two positions of the displaceable element 11 by way of example.

During a displacement of the displaceable element 11, the cross-sectional surface in the bleed channel 7 changes in the area of the displaceable element 11. This is due to the fact that the bleed channel 7 converges in the regarded section 72, so that the cross-sectional surface provided for the through-flow of compressor air becomes smaller the further the displaceable element 11 is displaced backwards in the axial direction. In FIGS. 2A, 2B, the smallest cross-sectional surface is indicated by A₁, A₂. It can be seen that, due to the converging course of the bleed channel 7 in section 72, the smallest cross-sectional surface A₂ is smaller in the position of the displaceable element 11 as it is shown in FIG. 2B than in the position shown in FIG. 2A with the smallest cross-sectional surface A₁.

The displaceable element 11 is embodied in a ring-shaped manner, for example, wherein it can extend across a certain circular arc in the bleed channel 7. Multiple such ring-shaped structures can be provided, respectively extending across a circular arc. Principally, the ring-shaped element 11 can also be embodied in a completely ring-shaped manner and consequently extend over an area of 360°, wherein it can be interrupted by structural elements, where necessary.

In another embodiment, the displaceable element 11 is realized as a disc element. Due to the fact that it modifies the cross-section of the bleed channel 7, the displaceable element 11 can also be referred to as a throttle.

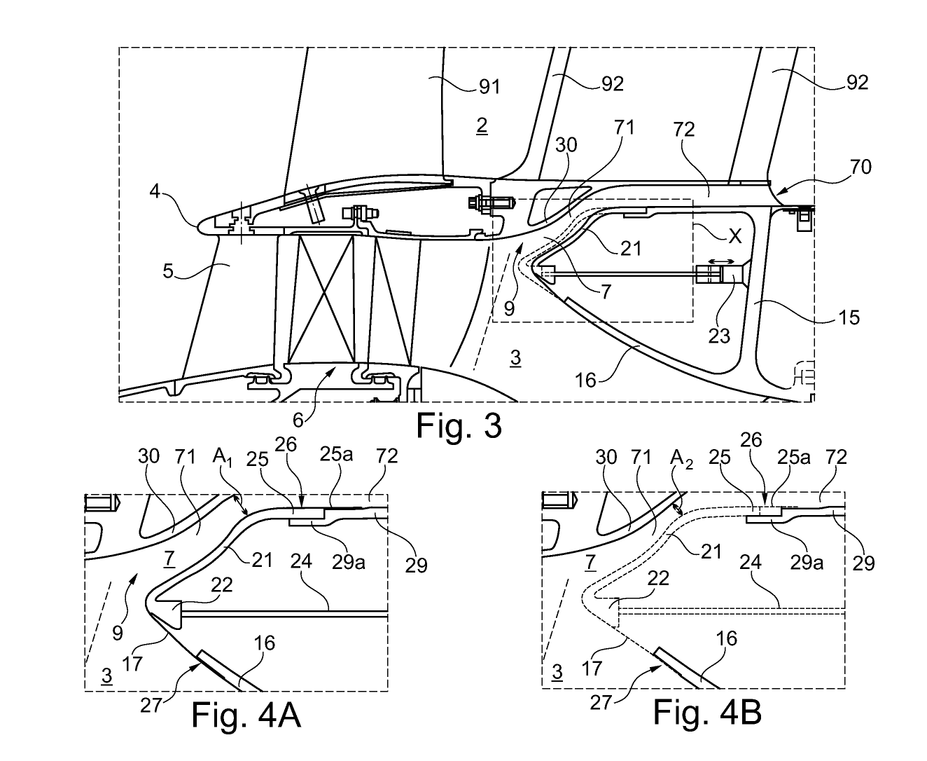

FIGS. 3, 4A, 4B show another exemplary embodiment of an adjustable channel geometry of a bleed channel 7. As far as the structural designs of bypass duct 2 and the primary flow channel 3 are concerned, the explanations provided in connection to FIGS. 1, 2A, 2B apply in a corresponding manner.

In the exemplary embodiment of FIGS. 3, 4A, 4B, a modifiable channel geometry is provided through an adjustable channel segment 21 that forms a component of the axially rear wall of the bleed channel 7. A modification of the cross-sectional surface and thus of the channel geometry is effected by the channel segment 21 being adjustable in a direction which has at least one component that extends obliquely with respect to the flow direction in the bleed channel 7.

In the exemplary embodiment of FIGS. 3, 4A, 4B, the adjustable channel segment 21 is formed at a section 71 of the bleed channel 7 that extends substantially in the radial direction or at least has a radial component. This is in contrast to section 72 of the bleed channel, which extends in parallel to the bypass duct 2 and accordingly in the axial direction.

For the purpose of displacing the channel segment 21, an actuator 23 is provided that is arranged in a stationary manner at a strut 15 and connected to a structurally reinforced partial area 22 of the channel segment 21 via a coupling rod 24 or another coupling means. Via the actuator 23, the channel segment 21 can be displaced in the axial direction, as shown by way of example in FIGS. 4A, 4B. During a displacement of the channel segment 21 in the axial direction, the bleed channel 7 is correspondingly rendered narrower or wider. Thus, the minimal cross-sectional surface A₂ of the bleed channel 7 is smaller in the position of FIG. 4B than the minimal cross-sectional surface A₁ in the position of FIG. 4A.

In order to achieve the displaceability of the signal segment 21 it is necessary to provide transition areas to the adjacent, non-displaceable channel segments or to other stationary housing segments. In the shown exemplary embodiment, this is effected by means of parallel guides 26, 27. Thus, a first parallel guide 26 is formed in the axially extending section 72 of the bleed channel 7 by way of an edge-side section 25 of the movable channel segment 21 extending in parallel to a section 29a of a stationary channel segment 29. A cover plate 25a that is connected to the section 25 serves for providing a smooth finish towards the bleed channel 7 throughout.

Further, the channel segment 21 is connected to a cover plate 17 which forms a parallel guide 27 with a stationary housing segment 16 in an overlapping area. Here, the cover plate 17 and the housing segment 16 do not confine the bleed channel 7, but the primary flow channel 3. This is due to the fact that the partial area 22 of the channel segment 21 adjoins the opening 9 towards the bleed channel 7. However, this is not necessarily the case.

Here again, the displaceable channel segment 21 can be embodied in a ring-shaped manner and can extend across a defined circular arc or can be completely embodied as a ring, wherein it can be interrupted by structural elements, if required.

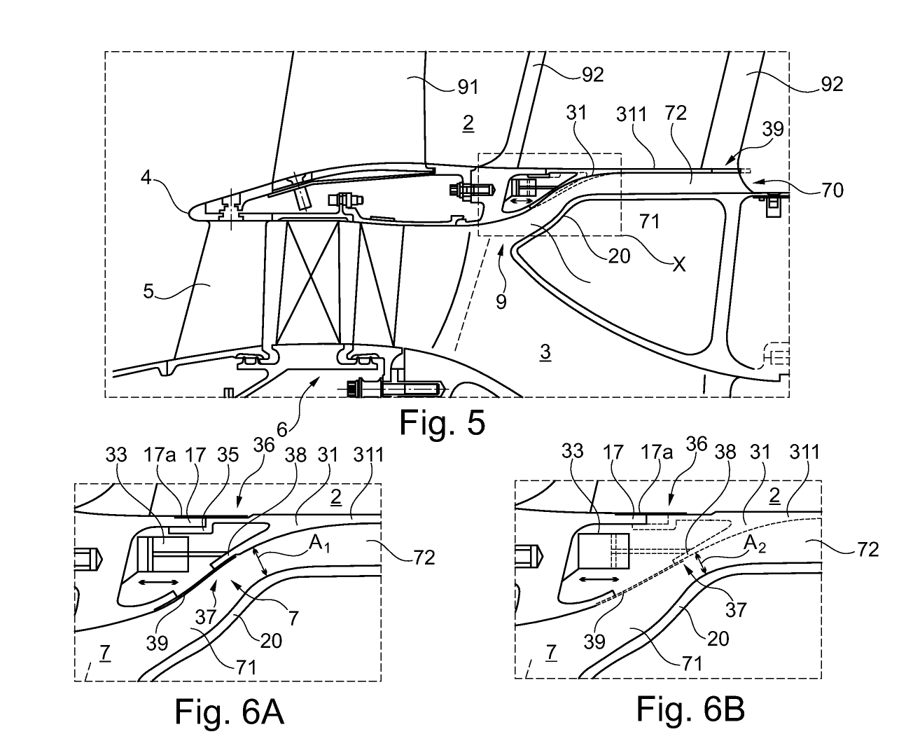

FIGS. 5, 6A, 6B show a third exemplary embodiment of an assembly according to the invention. As far as the structural designs of the bypass duct 2 and of the primary flow channel 3 are concerned, the explanation provided in connection to FIGS. 1, 2A, 2B apply in a corresponding manner.

The basic principle of the assembly of FIGS. 5, 6A, 6B is the same as in the exemplary embodiment of FIGS. 3, 4A, 4B in so far as a channel segment is designed to be obliquely displaceable in the flow direction of the bleed channel 7. In the exemplary embodiment of FIGS. 5, 6A, 6B, this displaceable channel segment is formed in a housing section that forms a front axial limitation of the bleed channel 7 with respect to the axial direction, while in the exemplary embodiment of FIGS. 3, 4A, 4B, the adjustable channel segment forms a rear axial limitation of the bleed channel 7.

Thus, in the exemplary embodiment of FIGS. 5, 6A, 6B, the adjustable channel segment 31 is embodied in the axially rear area of the very same structure that also forms the splitter 4. The channel segment 31 can be displaced in the axial direction by means of a stationary actuator 33 and a coupling rod 34 or another coupling means. During a displacement of the channel segment 31, the minimal cross-sectional surface in the bleed channel 7 decreases, as is shown in FIGS. 6A, 6B. The minimal cross-sectional surfaces are again indicated by A₁ and A₂.

Just like in the exemplary embodiment of FIGS. 3, 4A, 4B, in order to be able to realize the displaceability of the channel segment 31, overlapping areas with parallel guides 36, 37 are provided, at which sections 35, 38 of the moveable channel segment 31 on the one hand, and stationary housing areas 17, which adjoin the bypass duct 2, as well as stationary segments 39 of the bleed channel 7, on the other hand, overlap each other. A cover plate 17a that is connected to the area 17 serves for providing a smooth finish towards the bypass duct 2 throughout.

It is to be understood that in the exemplary embodiment of FIGS. 5, 6A, 6B, the channel segment 31, which is embodied in a displaceable manner, forms an extension 311 that confines the axially extending section 72 of the bleed channel 7 towards the bypass duct 2. Accordingly, a guide 39 that is not shown in any more detail is provided for the extension 311 in the area of the strut 92, as can be seen in FIG. 5.

In the exemplary embodiment of FIGS. 5, 6A, 6B, a reduction of the cross-sectional surface A₁, A₂ of the bleed channel 7 is achieved by at least partial areas of this segment 31 being moved in the direction of the facing boundary surfaces of the bleed channel 7 during the axial displacement of the channel segment 31.

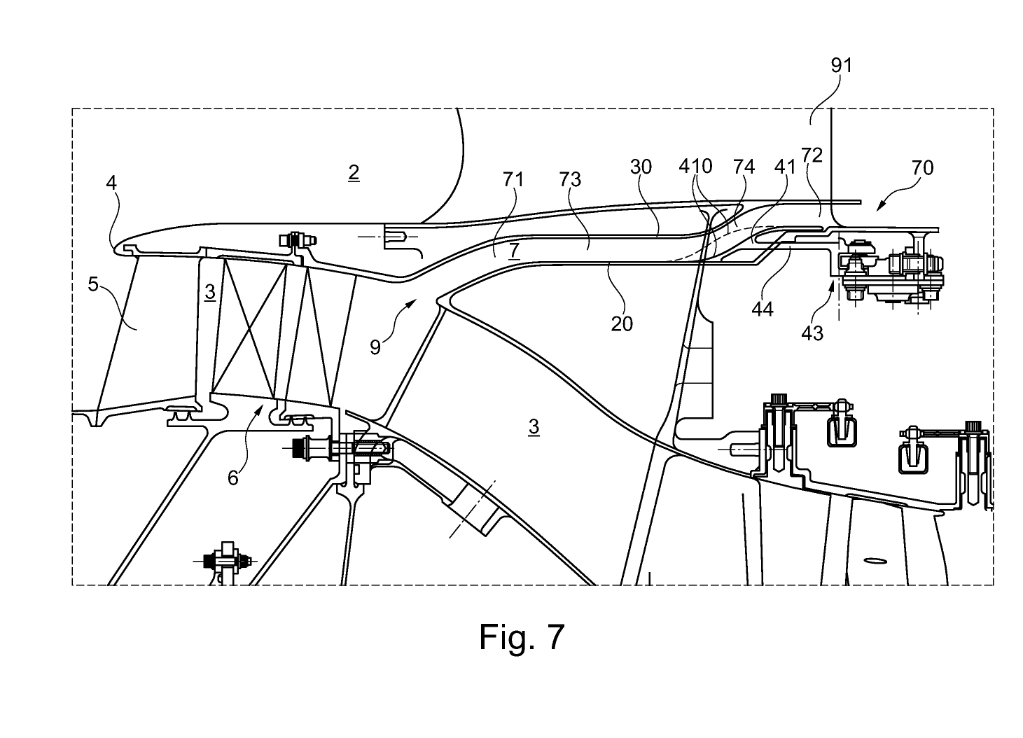

FIG. 7 shows an exemplary embodiment that illustrates a variation on the exemplary embodiments of FIGS. 1, 2A, 2B. Thus, in the exemplary embodiment of FIG. 7, a displaceable element 41 is provided that can be displaced in the axial direction inside the bleed channel 7 via an actuator 43 and coupling means 44.

The bleed channel 7 has such a design that a second section 73 connects to a first section 71, which has a radial component, with the second section 73 extending substantially in the axial direction and connecting to a third section 74, which in turn has a radial component and to which a fourth section 72 connects, which in turn has a substantially axial orientation and which has an end 70 that leads into the bypass duct 2. Here, the displaceable element 41 is arranged in the arcuate transition area between the sections 73 and 74 in such a manner that its boundary surfaces 410 approach the facing wall 30 as it is being axially displaced.

Thus, the arcuate transition area between the sections 73 and 74 of the bleed channel 7 is successively closed or reduced in its cross-sectional surface during the axial displacement of the displaceable element 41 against the flow direction.

It is to be understood that in all shown exemplary embodiments, before its end 70 which leads into the bypass duct 2, the bleed channel 7 extends in parallel to the bypass duct 2 along a longer section 72. This has the advantage that bled air that is exiting from the bleed channel 7 creates turbulences only to a small degree when entering the bypass duct 2, whereby pressure losses are avoided and an efficiency enhancement is achieved.

Further, it is to be understood that the transition areas between an adjustable channel segment and adjacent, stationary channel segments or other housing segments that are shown in FIGS. 3, 4A, 4B and 5, 6A, 6B can also be realized in a manner other than by using a parallel guide. For example, it can be provided that the displaceable channel segment is guided via a telescopic slide inside a stationary channel segment or housing segment. The shown embodiment variants are thus to be understood to be exemplary only.

In its embodiment, the invention is not limited to the shown exemplary embodiments. In particular the positions and shapes of the respective means by which the channel geometry of the bleed channel can be adjusted are to be understood as mere examples. Further, it should be understood that the features of the individual described exemplary embodiments of the invention can be combined with each other in different combinations. As far as areas are defined, they comprise all values within these areas as well as all partial areas belonging to an area.

1. An assembly for bleeding compressor air in an engine, wherein the assembly comprises a bleed channel for bleeding compressor air,
wherein the channel geometry of the bleed channel is adjustable.

2. The assembly according to claim 1, comprising means by which the cross-sectional surface of the bleed channel that if formed by the exterior boundary surfaces of the bleed channel can be modified at least in a partial area of the bleed channel.

3. The assembly according to claim 2, wherein the cross-sectional surface of the bleed channel can be continuously modified at least in a partial area of the bleed channel.

4. The assembly according to claim 1, wherein the bleed channel comprises a displaceable element which forms the limitation of the bleed channel in a partial area of the same with regard to the fluid flowing in the bleed channel, wherein the channel geometry is modified during the displacement of the displaceable element in the flow direction of the bleed channel.

5. The assembly according to claim 4, wherein the displaceable element is displaceable in the axial direction.

6. The assembly according to claim 4, wherein the displaceable element is embodied in a disc-shaped or ring-shaped manner.

7. The assembly according to claim 4, wherein the displaceable element is formed in a convex manner.

8. The assembly according to claim 4, wherein the displaceable element is arranged in a section of the bleed channel which extends in parallel to a bypass duct into which the compressor air is bled.

9. The assembly according to claim 4, wherein the displaceable element is arranged in a section of the bleed channel that tapers off and/or that is embodied in a curved manner.

10. The assembly according to claim 1, wherein at least one channel segment that confines the bleed channel is embodied in an adjustable manner.

11. The assembly according to claim 10, wherein the bleed channel is confined by a plurality of channel segments and at least some of the channel segments are embodied in an adjustable manner, namely in such a way that the distance of the channel segments with respect to each other can be modified.

12. The assembly according to claim 10, wherein the at least one channel segment is displaceable in the bleed channel substantially obliquely with respect to the flow direction or with a component extending obliquely with respect to the flow direction.

13. The assembly according to claim 10, wherein at least one channel segment is displaceable in the axial direction.

14. The assembly according to claim 10, wherein the displaceable channel segment forms a front or a rear axial limitation of the bleed channel in an area of the bleed channel in which the latter extends in a direction that has a radial component.

15. The assembly according to claim 10, wherein a parallel guide is realized by means of overlapping housing parts or a telescopic slide in the transition area of the at least one displaceable channel segment to stationary housing segments.

16. The assembly according to claim 1, further comprising at least one actuator via which a means for adjusting the channel geometry of the bleed channel can be adjusted.

17. The assembly according to claim 1, wherein the assembly additionally has a sealing element for sealing or partially sealing the bleed channel.

18. The assembly according to claim 1, wherein the bleed channel comprises a section that extends in parallel to a bypass duct into which the compressor air is bled.

19. An engine, in particular turbofan engine comprising an assembly with the features of claim 1.

20. A method for bleeding compressor air in an engine, in which compressor air to be bled from a compressor of the engine is guided into a bleed channel, wherein the channel geometry of the bleed channel is modified for the purpose of adjusting the mass flow of the compressor air to be bled.
